(19) United States
(12) Patent Application Publication
(10) Pub. No.: US 2022/0015373 A1
(43) Pub. Date: Jan. 20, 2022

(54) DRIED BIOLOGICAL COMPOSITIONS AND METHODS THEREOF

(71) Applicant: Evonik Operations GmbH, Essen (DE)

(72) Inventors: Christopher PROULX, Piscataway, NJ (US); Alexander PAASCHE, Haltern am See (DE); Mathias DERNEDDE, Bruchkoebel (DE); Sibylle SCHLEGEL-KACHEL, Bad Krozingen (DE); Juri TSCHERNJAEW, Aschaffenburg (DE); Jing WANG, Hackettstown, NJ (US); Stephen MOLLER, Rahway, NJ (US); Max BRAUN, Rothenburg (DE); Avaniek CABALES, Kendall Park, NJ (US); Stefan REMELÉ, Alzenau (DE); Eric G. LUNDQUIST, Camp Hill, PA (US); Saiid MOHAMMED, Henrico, VA (US)

(73) Assignee: Evonik Operations GmbH, Essen (DE)

(21) Appl. No.: 17/294,947

(22) PCT Filed: Nov. 21, 2019
(86) PCT No.: PCT/EP2019/082135

§ 371 Date: May 18, 2021

Related U.S. Application Data
(60) Provisional application No. 62/770,557, filed on Nov. 21, 2018.

(51) Int. Cl. A01N 63/27; A01N 25/08; A01N 25/26; A01N 63/22; A01N 63/23; A01N 63/20; A01P 7/04; A01P 3/00; A01P 5/00

(52) U.S. Cl. CPC A01N 63/27; A01N 25/08; A01N 25/26; A01N 63/22; A01P 5/00; A01N 63/20; A01P 7/04; A01P 3/00; A01N 63/23

(57) ABSTRACT

Dried and stable biological compositions may have high colony-forming units. Such compositions may include (1) a substrate and (2) micro-organism(s) loaded onto the surface of the substrate, wherein the composition has a total moisture content of about 0.01 wt. % to about 15 wt. %, preferably, about 0.01 wt. % to about 8 wt. %, preferably, about 3 wt. % to about 8 wt. %, preferably, about 5 wt. % to about 8 wt. %, still preferably, selected from 3 wt. %, 5 wt. % and 7 wt. %.

### TECHNICAL FIELD

The present disclosure relates generally to dried and stable biological compositions with high colony-forming units, and methods of making and using the same.

### BACKGROUND

Microbial insecticides, herbicides, fungicides and growth promoters that incorporate beneficial viruses, bacteria, yeast and fungi to target certain insect or plant species is a growing interest in the agricultural field due to its low impact on non-targeted species and the environment. Maintaining viability of these products, however, is generally a challenge during storage and formulation processing. Currently, microbial pesticide products may be prepared in liquid or dried formulations. Liquid formulations generally include suspensions of these microorganisms in water, oils or emulsions to maintain viability and efficacy. These liquid formulations, however, need to be stored and transported at low temperature, which, often times, are cumbersome and not cost effective. Dry formulations, on the other hand, generally include formulating the microorganisms into wettable powders, granules, prilled, coated or crystallized forms so as to allow for ease of storage and transportation. In order to be formulated into dried form for ease of handling, however, these microorganisms suffer cell death and stability issues due to the heat of drying in the formulation process.

U.S. Pat. No. 8,409,822 (Trevino et al.) discloses and claims compositions for delivering microorganisms in a dry mode comprising precipitated silica granules having a porous structure and microorganisms loaded throughout the pores of the precipitated silica granules, wherein the composition is operable to allow for propagation of the microorganisms within the pores of the precipitated silica granules. Also, U.S. Pat. No. 9,296,989 (Trevino et al.) discloses and claims compositions for delivering living cells in a dry mode comprising an inert carrier substrate having pores, living cells loaded within the pores of the inert carrier substrate and a surface layer disposed on an outer surface of the inert carrier substrate loaded with living cells, wherein the surface layer is permeable to molecules that aid in cell growth of the living cells such that the composition is operable to allow for increased propagation of the living cells within the inert carrier substrate as compared to another composition having an absence of the surface layer. Although the compositions of Trevino et al. are disclosed to be in “dry mode”, they are not in fact dried as the liquids including the living microorganisms are disclosed to be substantially loaded into the precipitated silica granule pores. The silica in Trevino et al. acts as an absorbent and is loaded with 25-75% of living microorganisms. At this level of loading, the loaded silica is free flowing defined as being dry to the touch. These compositions are relatively limited in utility because the concentration of the organisms and the water content in the silica are not optimized and will likely result in quick loss in activity as the organisms can still respire.

Various protectants such as sulfoxides, alcohols, monosaccharides, polysaccharides, amino acids, peptides, glycoproteins and other additive agents have been used to protect the microorganisms from dehydration damage. U.S. Pat. No. 5,360,607 (Eyal et al.) discloses and claims improved, stable, dried, prilled biopesticidal compositions comprising an inert carrier which is capable of supporting fungal growth and promoting conidia sporulation and an entomogenous fungal biomass prepared by submerged fermentation of the fungus, Paecilomyces fumosoroeus isolate. This method, however, uses alginate to encapsulate a natural prill which are subject to variations, particularly moisture content (e.g., water activity (A_{w}) level) which the microorganisms rely on to survive and respire.

There remains an unmet need in the art to prepare microorganisms in dry, stable form in high concentration.

### SUMMARY

The current inventors have surprisingly discovered that microorganisms such as mold spores and bacteria can be formulated and dried at a particular temperature onto the surface of various substrates to provide dried biological compositions with improved viability and a concentration or colony-forming unit (“CFU”) greater than that of the state of the art. To achieve the desired CFU level of these dried biological compositions (Concentrated Dried Biological Compositions), the current invention defines several interrelated parameters to create an optimal environment for the microorganisms to be deposited without sacrificing viability. First, a substrate is selected from a group of porous particles, e.g., precipitated particles with a BET surface area between 10 and 400 m²/g. Second, the microorganisms are dried onto such substrate to a target total water concentration between about 0.01 wt. % and about 15 wt. %. Achieving the total water concentration target in combination with the specific substrate parameter creates a defined water activity (A_{w}) as water activity is dependent on both the total amount of water and the relative availability of the water controlled by the specific substrate. The ability to customize an ideal surface water activity allows for the stabilization of the biological material in a desirable dormant state that is described by a low change to the colony-forming unit (“CFU”) overtime.

Therefore, in the first aspect, the invention provides a dried biological composition (Composition I) comprising, in a particular embodiment, consisting essentially of, and in another particular embodiment, consisting of, (i) a substrate and (ii) microorganisms loaded onto the surface of said substrate, wherein the composition has a total moisture content of about 0.01 wt. % to about 15 wt. %. It has been surprisingly discovered that microorganisms can be made to survive on certain substrate in a dormant state driven by the resultant surface water activity level, at high concentration and with good viability. Preferably in the first aspect, the invention provides Compositions I as follows:
1.1 Composition I, wherein the composition has a total moisture content of about 0.01 wt. % to about 8 wt. %;
1.2 Composition I or 1.1, wherein the composition has a total moisture content of about 3 wt. % to about 8 wt. %, preferably, about 5 wt. % to about 8 wt. %, still preferably, selected from 3 wt. %, 5 wt. % and 7 wt. %;
1.3 Composition I, or 1.1 or 1.2, wherein the composition has a water activity value (A_{w}) between about 0.01 and about 0.6, preferably, between about 0.2 and about 0.6, still preferably, between about 0.3 and about 0.5;
1.4 Composition I or any of 1.1-1.3, wherein the composition has greater than about 10⁷ CFU/g, preferably, greater than or equal to about 10⁸ CFU/g, still preferably, greater than or equal to about 10⁸ CFU/g, still preferably, greater than or equal to about 10¹⁰ CFU/g, still preferably, greater than or equal to about 10″ CFU/g, still preferably, greater than or equal to about 10¹² CFU/g;
1.5 Composition I or any of 1.1-1.4, wherein the substrate is selected from the group consisting of silica (e.g., precipitated silica, in a particular embodiment, hydrophilic silica, e.g., SIPERNAT® 22 silica), diatomaceous earth, silica gel, silicates (e.g., aluminosilicates such as ZEOLEX® 301, or clays) and water-insoluble natural fiber material such as cellulose;
1.6 Composition I or any of 1.1-1.5, wherein the substrate is silica;
1.7 Composition I or any of 1.1-1.6, wherein the substrate is precipitated silica;
1.8 Composition I or any of 1.1-1.7, wherein the substrate is hydrophilic silica, e.g., SIPERNAT® 22 silica;
1.9 Composition I or any of 1.1-1.5, wherein the substrate is water-insoluble natural fiber material such as cellulose;
1.10 Composition I or any of 1.1-1.5, wherein the substrate is diatomaceous earth;
1.11 Composition I or any of 1.1-1.5, wherein the substrate is silica gel;
1.12 Composition I or any of 1.1-1.5, wherein the substrate is silicates (e.g., aluminosilicates such as ZEOLEX® 301, or clays);
1.13 Composition I or any of 1.1-1.13, wherein the particle size (d50) of the substrate is about 5-200 microns, preferably, about 8-160 microns, still preferably, about 9-150 microns, still preferably, about 50-150 microns, still preferably, about 50-130 microns, still preferably, selected from a group consisting of about 50 microns, about 85 microns and about 120 microns;
1.14 Composition I or any of 1.1-1.14, wherein the BET surface area of the substrate is about 2-400 m²/g, preferably, about 5-400 m²/g, still preferably, about 10-400 m²/g, still preferably, about 30-400 m²/g, still preferably, about 30-300 m²/g, still preferably, about 40-200 m²/g, still preferably, about 180 m²/g;
1.15 Composition I or any of 1.1-1.14, wherein the BET surface area of the substrate is about 2 m²/g, preferably, about 5 m²/g;
1.16 Composition I or any of 1.1-1.14, wherein the BET surface area of the substrate is about 180 m²/g;
1.17 Composition I or any of 1.1-1.16, wherein the pore volume of the substrate is about 0.01-1.20 cc/g, preferably, about 0.05-1.20 cc/g, still preferably, about 0.10-1.0 cc/g, still preferably, about 0.20-0.95 cc/g;
1.18 Composition I or any of 1.1-1.17, wherein said composition comprises a precipitated silica having a BET surface area of about 50-200 m²/g, preferably, about 180 m²/g and said composition has a total moisture content of about 5 wt. % to about 8 wt. %;
1.19 Composition I or any of 1.1-1.18, wherein said composition comprises a precipitated silica having a BET surface area of about 50-200 m²/g, preferably, about 180 m²/g, and a particle size of about 5-200 microns, still preferably, about 120 microns, said composition has a total moisture content of about 5 wt. % to about 8 wt. %;
1.20 Composition I or any of 1.1-1.19, wherein the final micro-organism concentration is between about 4 and about 40 wt. %, preferably, about 4 and about 20 wt. % of the total composition;
1.21 Composition I or any of 1.1-1.20, wherein, the micro-organisms are selected from the group consisting of Bacillus subtilis QST713, Pasteuria usgae; Beauveria bassiana, Coniothyrium minitans, Chondrostereum purpureum, Paecilomyces lilacinus, Aschersonia aleyrodis, Beauveria brongniartii, Hirsutella thompsonii, Isaria fumosorosea, Isaria sp., Lecanicillium longisporum, Lecanicillium muscarium, Lecanicillium sp., Metarhizium anisopliae, Metarhizium anisopliae var. acridum, Nomuraea rileyi Sporothrix insectorum; Cydia pomonella GV; Phytophthora palmivora, Lagenidium giganteum, Bacillus thuringiensis, Pseudomonas fluorescens, Bradyrhizobium, Mycorrhiza, Clonostachys rosea, Bacillus spp. and Lactobacillus spp., or any combinations thereof, preferably, selected from the group consisting of Bacillus thuringiensis, Pseudomonas fluorescens, Bradyrhizobium, Mycorrhiza, Clonostachys rosea and any combinations thereof;
1.22 Composition I or any of 1.1-1.21, wherein, the microorganisms are Clonostachys rosea, in another embodiment, Pseudomonas fluorescens;
1.23 Composition I or any of 1.1-1.22 further comprising one or more excipient, in a particular embodiment, one or more agrochemically acceptable excipient;
1.24 Composition 1.22 in tablet form, flowable concentrate form, e.g., for seed treatment, or in oil dispersion form;
1.25 Composition I or any of 1.1-1.24, wherein the composition does not require exogenous protectant such as alginate encapsulation;
1.26 Composition I or any of 1.1-1.25, wherein the composition further comprises a polymer selected from the group consisting of polyvinyl alcohol, xanthan gum, gum arabic, other polysaccharides such as maltodextrin, guar gum (e.g., hydroxypropyl guar gum), and polyethylene glycol;
1.27 Composition I or any of 1.1-1.26, wherein the composition further comprises a second substrate as an outer layer;
1.28 Composition 1.27, wherein the second substrate is selected from a precipitated silica such as SIPERNAT® 50 S silica, e.g., or a fumed silica such as AEROSIL® 200, AEROSIL® R 972 or AEROSIL® R 812S silica;
1.29 Composition I or any of 1.1-1.28, wherein the number of colony forming units per gram of the composition (CFU/g) remains above about 10⁷ CFU/g after storage at room temperature for 120 days;
1.30 Composition I or any of 1.1-1.29, wherein the number of colony forming units per gram of the composition (CFU/g) remains above about 10⁷ CFU/g after storage at 40° C. for 40 days;
1.31 Composition I or any of 1.1-1.30, wherein the number of colony forming units per gram of the composition (CFU/g) remains above about 10⁷ CFU/g after storage at a relative humidity of 65% or lower for 40 days;
1.32 Composition I or any of 1.1-1.31, wherein the tap density of the composition is greater than 150% of the tapped density of the pure substrate material;
1.33 Composition I or any of 1.1-1.32, wherein the microorganisms are larger than the pore diameter of the substrate or the microorganisms are loaded onto the surface of the substrates;
1.34 Composition I or any of 1.1-1.24 or 1.27-1.33, wherein the composition further comprises (i) a polymer selected from the group consisting of polyvinyl alcohol, xanthan gum, gum arabic, or other polysaccharides such as maltodextrin, guar gum (e.g., hydroxypropyl guar gum), polyethylene glycol, and polyglycerol, or (ii) non-reducing disaccharides such as trehalose or sucrose, or (iii) skim milk or dimethyl sulfoxide;
1.35 Composition I or any of 1.1-1.24 or 1.27-1.33, wherein the composition further comprises non-reducing disaccharides such as trehalose or sucrose;
1.36 Composition I or any of 1.1-1.24 or 1.27-1.33, wherein the composition further comprises a polymer such as a polyglycerol, particularly hyperbranched polyglycerol polymer;
1.37 Composition I or any of 1.1-1.36, wherein said secondary substrate is a finely divided hydrophobic or hydrophilic particles wherein such particle is surface treated, e.g., with silanes or silicon oil to modify the wettability or the tendency for the samples to absorb water;
1.38 Composition I or any of 1.1-1.37, wherein said secondary substrate is a silica or clay wherein such silica or clay is surface treated, e.g., with silanes or silicon oil to modify the wettability or the tendency for the samples to absorb water;
1.39 Composition I or any of 1.1-1.38, wherein the second substrate has a high BET surface area, e.g., 50 to 750 m²/g, in a particular embodiment, 50-380 m²/g;
1.40 Composition I or any of 1.1-1.39, wherein the second substrate is a hydrophobic silica;
1.41 Composition I or any of 1.1-1.40, wherein the second substrate is a precipitated silica;
1.42 Composition I or any of 1.1-1.41, wherein the second substrate is a precipitated silica with a high BET surface area, e.g., 50 to 750 m²/g, in a particular embodiment, 50-380 m²/g;
1.43 Composition I or any of 1.1-1.42, wherein the second substrate is SIPERNAT® 50 or ZEOFREE® silica, in a particular embodiment; SIPERNAT® 50 silica;
1.44 Composition I or any of 1.1-1.40, wherein the second substrate is a fumed silica;
1.45 Composition I or any of 1.1-1.44, wherein the second substrate is fumed silica;
1.46 Composition I or any of 1.1-1.44, wherein the second substrate is a hydrophobic fumed silica;
1.47 Composition I or any of 1.1-1.44, wherein the second substrate is a hydrophobic fumed silica having a BET surface area 180 to 220 m²/g and a carbon content of 3.5 to 5% such as AROSIL® R202 silica;
1.48 Composition I or any of 1.1-1.6, 1.13, 1.17 or 1.20-1.47, wherein the primary substrate is a silica with a BET surface area of 400-600 m²/g, preferably, 500 m²/g;
1.49 Composition 1.48, wherein said silica has a pore volume of great than 1 cc/g, preferably 1.4 cc/g by Barrett-Joyner-Halenda model or great than 2 cc/g, preferably 2.2 by Mercury Pore Volume;
1.50 Composition 1.49, wherein the silica is SIPERNAT® 50 silica.

In the second aspect, the invention provides a process for the preparation of a dried biological composition comprising, in a particular embodiment, consisting essentially of, and in another particular embodiment, consisting of, a substrate and microorganisms loaded onto the substrate, wherein the composition has a moisture content of about 0.01 wt. % to about 15 wt. %, which process comprises, in a particular embodiment, consists essentially of, and in another particular embodiment, consists of the steps of (1) combining a mixture, solution or suspension containing microorganisms with a substrate; and (2) drying the substrate-microorganism mixture to reach a total moisture content of about 0.01 to about 15 wt. % (Process I). Preferably, the invention provides Process I as follows:
2.1 Process I, wherein the microorganisms are harvested from the surface of a seed by mechanically grinding or polishing the surface of the seed (step (a)) resulting in a fine fraction containing microorganisms, preferably, containing fungal spores, and some parts of the seed. Preferably, the yield of microorganisms in the fine fraction is greater than 10⁹ cfu/per gram of initially ground or polished seed. Still preferably, the process comprises sieving (step (b)) the resulting fine fraction in order to obtain a powder with a defined particle size distribution for the subsequent process steps. Preferably, the powder is used to prepare a microorganism mixture, solution or suspension (step c);
2.2 The process 2.1, wherein step (a) comprises grinding with a grinding stone for separating the seed form the fine fraction;
2.3 The process 2.1, wherein step (a) comprises grinding with a rotating shaft inside an enclosing tube of a slotted screen in condition of under pressure with following of a sifter and a filter for separating the seed form the fine fraction;
2.4 The process I or any of 2.1-2.3, wherein the sieving of the fine fraction step (b) comprises the sieving with a sieve mesh size of 20 to 800 μm, preferably from 100 μm to 300 μm;
2.5 The process I, wherein the microorganisms are harvested from the surface of a seed by washing them off with water and separating the seed and the liquid microorganism solution or suspension. Preferably, the seed is stirred in water for 1 to 20 min. Still preferably, solid-liquid separation is done in a pressure nutsche filter, still preferably, the mesh size of 1 to 3 mm is used in the pressure nutsche filter. Still preferably, the dewatering time in the pressure nutsche filter is 20-200 seconds. Still preferably, the filtration pressure in the nutsch filter is 1 to 3 bar. Still preferably, the microorganism solution or suspension is concentrated by separating the microorganisms from the liquid in a centrifugal field. Still preferably, the concentration step comprises separation in a disc stack separator. still preferably, the concentration step is repeated with dilution of the concentrate with water and a subsequent second concentration in a centrifugal field to separate soluble parts from the microorganisms;
2.6 Process I or any of 2.1-2.5, wherein, wherein step (2) dries the substrate-microorganism mixture to a total moisture content of about 0.01 wt. % to about 15 wt. %, preferably, about 0.01 wt. % to about 8 wt. %, still preferably, about 3 wt. to about 8 wt. %, still preferably, about 5 wt. % to about 8 wt. %, still preferably selected from 3 wt. %, 5 wt. % and 7 wt. %;
2.7 Process I or any of 2.1-2.6, wherein drying step (2) comprises fluid bed drying the substrate-microorganism mixtures;
2.8 Process I or any of 2.1-2.6, wherein drying step (2) comprises spray drying the substrate-microorganism mixture;
2.9 Process I or any of 2.1-2.6, wherein drying step (2) comprises contact drying the substrate microorganism mixture;
2.10 Process I or any of 2.1-2.6, wherein drying step (2) comprises freeze drying the substrate-microorganism mixture
2.11 Process I or any of 2.1-2.10, wherein the temperature of the drying air is less than or equal to about 130° C., preferably, less than or equal to about 90° C., still preferably, less than or equal to about 80° C., still preferably, less than or equal to about 50° C., still preferably, at about 30°−50° C., still preferably, at about 40°−50° C., still preferably, at about 40°−45° C., still preferably, at about 43° C.;
2.12 Process I or any of 2.1-2.11, wherein the powder bed is maintained at less than or equal to about 35° C., preferably, less than or equal to about 30° C., still preferably, between about 25° C. and 35° C.;
2.13 Process I or any of 2.1-2.7, wherein the rate of spraying is about 2 mL/g of substrate;
2.14 Process I or any of 2.1-2.13, wherein the resulting composition has a water activity value (A_{w}) between about 0.01 and about 0.6, preferably, between about 0.2 and about 0.6, still preferably, between about 0.3 and about 0.5;
2.15 Process I or any of 2.1-2.14, wherein the resulting composition has a colony-forming units of micro-organisms per gram of the composition (CFU/g), e.g., at greater than 10⁷ CFU/g, preferably at greater than or equal to about 10⁸ colony-forming units per gram (CFU/g), preferably, greater than or equal to about 10⁸ CFU/g, still preferably, greater than or equal to about 10¹⁰ CFU/g still preferably, greater than or equal to about 10¹¹ CFU/g, still preferably, greater than or equal to about 10¹² CFU/g;
2.16 Process I or any of 2.1-2.15, wherein the substrate is selected from the group consisting of silica (e.g., precipitated silica, in a particular embodiment, hydrophilic silica, e.g., SIPERNAT® 22 silica), diatomaceous earth, silica gel, silicates (e.g., aluminosilicates such as ZEOLEX® 301, or clays) and water-insoluble natural fiber material such as cellulose;
2.17 Process I or any of 2.1-2.16, wherein the substrate is silica;
2.18 Process I or any of 2.1-2.17, wherein the substrate is precipitated silica;
2.19 Process I or any of 2.1-2.18, wherein the substrate is a hydrophilic silica, e.g., SIPERNAT® 22 silica;
2.20 Process I or any of 2.1-2.16, wherein the substrate is water-insoluble natural fiber material such as cellulose;
2.21 Process I or any of 2.1-2.16, wherein the substrate is diamaceous earth;
2.22 Process I or any of 2.1-2.16, wherein the substrate is silica gel;
2.23 Process I or any of 2.1-2.16, wherein the substrate is silicates (e.g., aluminosilicates such as ZEOLEX® 301, or clays);
2.24 Process I or any of 2.1-2.23, wherein the particle size (d50) of the substrate is about 5-200 microns, preferably, about 8-160 microns, still preferably, about 9-150 microns, still preferably, about 50-150 microns, still preferably, about 50-130 microns, still preferably, selected from a group consisting of about 50 microns, about 85 microns and about 120 microns;
2.25 Process I or any of 2.1-2.24, wherein the BET surface area of the substrate is about 2-400 m²/g, preferably, about 5-400 m²/g, still preferably, about 10-400 m²/g, still preferably, about 30-400 m²/g, still preferably, about 30-300 m²/g, still preferably, about 40-200 m²/g, still preferably, about 180 m²/g;
2.26 Process I or any of 2.1-2.25, wherein the BET surface area of the substrate is about 2 m²/g, preferably, about 5 m²/g;
2.27 Process I or any of 2.1-2.25, wherein the BET surface area of the substrate is about 180 m²/g;
2.28 Process I or any of 2.1-2.27, wherein the pore volume of the substrate is about 0.01-1.20 cc/g, preferably, about 0.05-1.20 cc/g, still preferably, about 0.10-1.0 cc/g, still preferably, about 0.20-0.95 cc/g;
2.29 Process I or any of 2.1-2.28, wherein said composition comprises a precipitated silica having a BET surface area of about 50-200 m²/g, preferably, about 180 m²/g and said composition has a total moisture content of about 5 wt. % to about 8 wt. %;
2.30 Process I or any of 2.1-2.29, wherein said composition comprises a precipitated silica having a BET surface area of about 50-200 m²/g, preferably, about 180 m²/g, and a particle size of about 5-200 microns, still preferably, about 120 microns, said composition has a total moisture content of about 5 wt. % to about 8 wt. %;
2.31 Process I or any of 2.1-2.30, wherein step (1) comprises loading between about 4 and about 40 wt. %, preferably, about 4 and about 20 wt. % of the total composition;
2.32 Process I or any of 2.1-2.31, wherein step (1) further comprises adding polymer selected from the group consisting of polyvinyl alcohol, xanthan gum, gum arabic and other polysaccharides such as maltodextrin, guar gum (e.g., hydroxypropyl guar gum), and polyethylene glycol;
2.33 Process I or any of 2.1-2.32, wherein step (1) further comprises a second substrate as an outer layer;
2.34 Process 2.33, wherein second substrate is selected from a precipitated silica such as SIPERNAT® 50 S silica, e.g., or a fumed silica such as AEROSIL® 200, AEROSIL® R 972 or AEROSIL® R 812S silica;
2.35 Process I or any of 2.1-2.34, wherein the micro-organisms are selected from the group consisting of Bacillus subtilis QST713, Pasteuria usgae; Beauveria bassiana, Coniothyrium minitans, Chondrostereum purpureum, Paecilomyces lilacinus, Aschersonia aleyrodis, Beauveria brongniartii, Hirsutella thompsonii, Isaria fumosorosea, Isaria sp., Lecanicillium longisporum, Lecanicillium muscarium, Lecanicillium sp., Metarhizium anisopliae, Metarhizium anisopliae var. acridum, Nomuraea rileyi Sporothrix insectorum; Cydia pomonella GV; Phytophthora palmivora, Lagenidium giganteum, Bacillus thuringiensis, Pseudomonas fluorescens, Bradyrhizobium, Mycorrhiza, Clonostachys rosea, Bacillus spp. and Lactobacillus spp., or any combinations thereof;
2.36 Process I or any of 2.1-2.34, wherein the micro-organisms are selected from the group consisting of Bacillus thuringiensis, Pseudomonas fluorescens, Bradyrhizobium, Mycorrhiza, Clonostachys rosea;
2.37 Process I or any of 2.1-2.34, wherein the micro-organisms are Clonostachys rosea;
2.38 Process I or any of 2.1-2.34, wherein the resulting composition does not require exogenous protectant such as alginate encapsulation;
2.39 Process I or any of 2.1-2.38, wherein the number of colony forming units per gram of the composition (CFU/g) remains above 10⁷ CFU/g after storage at room temperature for 120 days;
2.40 Process I or any of 2.1-2.39, wherein the number of colony forming units per gram of the composition (CFU/g) remains above 10⁷ CFU/g after storage at 40° C. for 40 days;
2.41 Process I or any of 2.1-2.40, wherein the number of colony forming units per gram of the composition (CFU/g) remains above 10⁷ CFU/g after storage at a relative humidity of 65% or lower for 40 days;
2.42 Process I or any of 2.1-2.41, wherein the tap density of the composition is greater than 150% of the tapped density of the pure substrate material;
2.43 Process I or any of 2.1-2.31 or 2.33-2.37 or 2.39-2.42, wherein the composition further comprises (i) a polymer selected from the group consisting of polyvinyl alcohol, xanthan gum, gum arabic, or other polysaccharides such as maltodextrin, guar gum (e.g., hydroxypropyl guar gum), polyethylene glycol, and polyglycerol, or (ii) non-reducing disaccharides such as trehalose or sucrose, or (iii) skim milk or dimethyl sulfoxide;
2.44 Process I or any of 2.1-2.31 or 2.33-2.37 or 2.39-2.42, wherein the composition further comprises non-reducing disaccharides such as trehalose or sucrose;
2.45 Process I or any of 2.1-2.31 or 2.33-2.37 or 2.39-2.42, wherein the composition further comprises a polymer such as a polyglycerol, particularly hyperbranched polyglycerol polymer;
2.46 Process I or any of 2.1-2.33 or 2.35-2.45, wherein said secondary substrate is a finely divided hydrophobic or hydrophilic particles wherein such particle is surface treated, e.g., with silanes or silicon oil to modify the wettability or the tendency for the samples to absorb water;
2.47 Process I or any of 2.1-2.33 or 2.35-2.45, wherein said secondary substrate is a silica or clay wherein such silica or clay is surface treated, e.g., with silanes or silicon oil to modify the wettability or the tendency for the samples to absorb water;
2.48 Process I or any of 2.1-2.33 or 2.35-2.45, wherein said secondary substrate is has a high BET surface area, e.g., 50 to 750 m²/g, in a particular embodiment, 50-380 m²/g;
2.49 Process I or any of 2.1-2.33 or 2.35-2.48, wherein the second substrate is a hydrophobic silica;
2.50 Process I or any of 2.1-2.33 or 2.35-2.49, wherein the second substrate is a precipitated silica;
2.51 Process I or any of 2.1-2.33 or 2.35-2.50, wherein the second substrate is a precipitated silica with a high BET surface area, e.g., 50 to 750 m²/g, in a particular embodiment, 50-380 m²/g;
2.52 Process I or any of 2.1-2.33 or 2.35-2.50, wherein the second substrate is SIPERNAT® 50 or ZEOFREE® silica, in a particular embodiment; SIPERNAT® 50 silica;
2.53 Process I or any of 2.1-2.33 or 2.35-2.45, wherein the second substrate is a hydrophobic fumed silica having a BET surface area 180 to 220 m²/g and a carbon content of 3.5 to 5% such as AROSIL® R202 silica;
2.54 Process I or any of 2.1-2.33 or 2.35-2.45, wherein the second substrate is Aerosil® R202 silica;
2.55 Process I or any of 2.1-2.18, 2.24, 2.28, 2.31-2.54, wherein the BET surface area of the primary substrate is 400-600, m²/g, preferably, 500 m²/g;
2.56 Process 2.55, wherein said substrate has a pore volume of great than 1 cc/g, preferably 1.4 cc/g by Barrett-Joyner-Halenda model or great than 2 cc/g, preferably 2.2 by Mercury Pore Volume;
2.57 Process I or any of 2.33-2.56, wherein the second substrate is added to the microorganism suspension before said drying step (2);
2.58 Process I or any of 2.33-2.56, wherein the second substrate is added to the microorganism suspension during said drying step (2);
2.59 Process I or any of 2.33-2.56, wherein the second substrate is added to the microorganism suspension after said drying step (2);
2.60 Process I or any of 2.32-2.59, wherein the polymer or polysaccharide or non-reducing disaccharide is added into the microorganisms suspension before said drying step (2);
2.61 Process I or any of 2.32-2.59, wherein the polymer or polysaccharide or non-reducing disaccharide is added into the microorganisms suspension during said drying step (2);
2.62 Process I or any of 2.32-2.59, wherein the polymer or polysaccharide or non-reducing disaccharide is added into the microorganisms suspension after said drying step (2);
2.63 Process I or any of the foregoing, wherein the microorganisms are harvested from the surface of a seed by mechanically grinding or polishing the surface of the substrate (step (a)) resulting in a fine fraction including microorganisms, preferably fungal spores, and some parts of the seed. Preferably, the yield of microorganisms in the fine fraction is greater than 10⁹ cfu/per gram of initially ground or polished seed. Still preferably, the process comprises sieving (step (b)) the resulting fine fraction in order to obtain a powder with a defined particle size distribution for the subsequent process steps. Still preferably, the powder is used to prepare a microorganism mixture, solution or suspension (step (c));
2.64 Process 2.63, wherein step (a) comprises grinding the seed with a grinding stone to separate from the fine fraction;
2.65 Process 2.63, wherein step (a) comprises grinding with a rotating shaft inside an enclosing tube of a slotted screen in condition of under pressure with following of a sifter and a filter for separating the seed form the fine fraction;
2.66 Process 2.63, wherein the sieving step (b) of the fine fraction comprises sieving with a sieve mesh size of 20 to 800 μm, preferably from 100 μm to 300 μm;
2.67 Process I or any of formulae 2.1-2.63, wherein the microorganisms are harvested from the surface of a seed by washing them off with water and separating the seed and the liquid microorganism solution or suspension. Preferably, the seed is stirred in water for 1 to 20 min. Still preferably, the solid-liquid separation is done in a pressure nutsche filter. Preferably, a mesh size of 1 to 3 mm is used in the pressure nutsche filter. Still preferably, the dewatering time in the pressure nutsche filter is 20-200 seconds. Still preferably, the filtration pressure in the nutsch filter is 1 to 3 bar. Still preferably, the microorganism solution or suspension is concentrated by separating the microorganisms from the liquid in a centrifugal field. Still preferably, the concentration step comprises separation in a disc stack separator. Still preferably, the concentration step is repeated with dilution of the concentrate with water and a subsequent second concentration in a centrifugal field to separate soluble parts from the microorganisms;
2.68 Process I or any of the foregoing, wherein drying step (2) comprises fluid bed drying the substrate-microorganism mixtures;
2.69 Process I or any of the foregoing, wherein drying step (2) comprises spray drying the substrate-microorganism mixtures;
2.70 Process I or any of the foregoing, wherein drying step (2) comprises contact drying the substrate-microorganism mixtures;
2.71 Process I or any of the foregoing, wherein drying step (2) comprises freeze drying the substrate-microorganism mixtures;
2.72 Process I or any of the foregoing, wherein the temperature of the drying air is less than or equal to about 130° C., in a particular embodiment, less than or equal to about 90° C., preferably, less than or equal to about 80° C., still preferably, less than or equal to about 50° C., still preferably, at about 30°-50° C., still preferably, at about 40°-50° C., still preferably, at about 40°-45° C., still preferably, at about 43° C.;
2.73 Process I or any of the foregoing, wherein the powder bed is maintained at less than or equal to about 35° C., preferably, about 25° C. to about 35° C.;
2.74 Process I or any of the foregoing, wherein the resulting composition has a water activity value (A_{w}) Between about 0.01 and about 0.6, Preferably, Between about 0.2 and about 0.6, still preferably, between about 0.3 and about 0.5;
2.75 Process I or any of the foregoing, wherein the resulting composition has a colony-forming units of microorganisms per gram of composition (CFU/g), e.g., greater than about 10⁷ CFU/g, preferably at greater than or equal to about 10⁸ colony-forming units per gram (CFU/g), preferably, greater than or equal to about 10⁸ CFU/g, still preferably, greater than or equal to about 10¹⁰ CFU/g, still preferably, greater than or equal to about 10¹¹ CFU/g, still preferably, greater than or equal to about 10¹² CFU/g;
2.76 Process I or any of the foregoing, wherein the temperature of the drying air is less than or equal to about 130° C., in a particular embodiment, less than or equal to about 90° C., preferably, less than or equal to about 80° C., still preferably, less than or equal to about 50° C., still preferably, at about 30°−50° C., still preferably, at about 40°−50° C., still preferably, at about 40°−45° C., still preferably, at about 43° C.;
2.77 Process I or any of the foregoing, wherein the powder bed is maintained at less than or equal to about 35° C., preferably, about 25° C. to about 35° C.;
2.78 Process I or any of the foregoing, wherein the resulting composition has a water activity value (A_{w}) between about 0.01 and about 0.6, preferably, between about 0.2 and about 0.6, still preferably, between about 0.3 and about 0.5;
2.79 Process I or any of the foregoing, wherein the resulting composition has a colony-forming units of microorganisms per gram of composition (CFU/g), e.g., greater than about 10⁷ CFU/g, preferably at greater than or equal to about 10⁸ colony-forming units per gram (CFU/g), preferably, greater than or equal to about 10⁸ CFU/g, still preferably, greater than or equal to about 10¹⁰ CFU/g, still preferably, greater than or equal to about 10¹¹ CFU/g, still preferably, greater than or equal to about 10¹² CFU/g;

In the third aspect, the invention provides a dried biological composition (Composition II′) prepared by Process I or any of 2.1-2.79 of the current invention. In another embodiment of the third aspect, the invention provides, a dried biological composition (Composition II-A) prepared by Process I or any of 2.1-2.42 of the current invention. In still another embodiment of the third aspect, the invention provides a dried biological composition (Composition II-B) prepared by Process I or any of 2.43-2.79 of the current invention

The compositions of the current invention is also useful for applying to seeds to protect them from pests or to provide a micro-organisms with biostimulant function such as liberation of phosphorus or supply nitrogen. Therefore, in the fourth aspect, the invention provides Composition I or any of 1.1-1.50 or Composition II′ or any of 2.1-2.79, further comprising, in a particular embodiment, consisting essentially of and in another particular embodiment, consisting of, a seed to be treated (Composition III′). In a further embodiment of the fourth aspect, the invention provides Composition I or any of 1.1-1.33 or Composition II-A, further comprising, in a particular embodiment, consisting essentially of and in another particular embodiment, consisting of, a seed to be treated (Composition III-A). In still another embodiment of the fourth aspect, the invention provides Composition I or any of 1.34-1.50 or Composition II-B, further comprising, in a particular embodiment, consisting essentially of and in another particular embodiment, consisting of, a seed to be treated (Composition III-B). These compositions may optionally comprise a colorant.

In the fifth aspect, the invention provides a method for controlling insect, fungus, or nematode on an area to be treated, comprising optionally reconstituting the concentrated dried biological composition of the invention (i.e., any of Composition I or any of 1.1-1.50), or Composition II′ or any of 2.1-2.79 or Composition III′) and applying an effective amount of the (optionally reconstituted) concentrated dried biological composition of the invention to the area to affect treatment. In a further embodiment of fifth aspect, the invention provides a method for controlling insect, fungus, or nematode on an area to be treated, comprising optionally reconstituting the concentrated dried biological composition of the invention (i.e., any of Composition I or any of 1.1-1.33, or Composition II-A or Composition III-A) and applying an effective amount of the (optionally reconstituted) concentrated dried biological composition of the invention to the area to affect treatment. In still another embodiment of the fifth aspect, the invention provides a method for controlling insect, fungus, or nematode on an area to be treated, comprising optionally reconstituting the concentrated dried biological composition of the invention (i.e., Composition I or any of 1.34-1.50), Composition II-B or any of 2.43-2.79 or Composition III-B) and applying an effective amount of the (optionally reconstituted) concentrated dried biological composition of the invention to the area to affect treatment. In one embodiment, the area is to be treated is a portion of a plant, including without limitation, vegetative cutting, root, bulb, tuber, stem, fruit, flower and/or leaf of the plant, e.g., corn, wheat, sorghum, soybeans, citrus and non-citrus fruits, nut trees, and the like. In another embodiment, the area to be treated is soil or seeds or mixtures thereof.

### BRIEF DESCRIPTION OF THE DRAWING

FIG. 1 shows Plot of log CFU over time for Examples 12-23 stored at 40° C. Samples are labelled by additives.

FIG. 2 shows the Decimal reduction time, in units of weeks, for Examples 12-23 stored at 40° C. Error bars are the standard error of the regression.

FIG. 3 shows the decline of log (CFU) over time for Examples 12-23 stored at elevated humidity.

FIG. 4 shows the Decimal Reduction Time for each sample stored at elevated humidity. Error bars represent the standard error of the regression.

### DETAILED DESCRIPTION

The current invention provides for a system to deliver microorganisms (e.g., microbial pesticides such as mold spores and other bacteria) in a dried and stable form and at a high CFU compared to those in the prior art. It is discovered that microorganisms can be dried onto certain substrates, e.g., using methods disclosed herein, to a target total water concentration between about 0.01 wt. % and about 15 wt. % to create a surface suitable for the biological material to be in a dormant state. Exemplary substrate useful for the current invention include, but are not limited to, silica, in a particular embodiment, precipitated silica, in still another particular embodiment, hydrophilic silica, in a specific embodiment SIPERNAT® 22 silica. Other exemplary substrate also includes diatomaceous earth, silica gel, silicates (e.g., aluminosilicates such as ZEOLEX® 301, or clay) and water-insoluble natural fiber material such as cellulose. In still another embodiment, the substrate is a a silica with a BET surface area of 400-600, m²/g, preferably, 500 m²/g. In a further embodiment, said silica has a pore volume of great than 1 cc/g, preferably 1.4 cc/g by Barrett-Joyner-Halenda model or great than 2 cc/g, preferably 2.2 by Mercury Pore Volume, preferably SIPERNAT® 50 silica.

Typical particle size of the substrate of the compositions of the current invention may have a d50 of about 5-200 microns, preferably, about 8-160 microns, preferably, about 9-150 microns, still preferably, about 50-150 microns, still preferably, about 50-130 microns, still preferably, selected from a group consisting of about 50 microns, about 85 microns and about 120 microns. Particle size of silica may be measured by any method known to one skilled in the art, e.g., such as dry particle size analysis using laser light scattering or Scanning Electron Microscopy (SEM) analysis.

Typical BET surface area of the substrates of the composition of the current invention is about 2-400 m²/g, preferably, about 5-400 m²/g, preferably, about 10-400 m²/g, still preferably, about 30-400 m²/g, still preferably, about 30-300 m²/g, still preferably, about 40-200 m²/g, still preferably, about 180 m²/g. BET surface area of silica substrate is about 10-400 m²/g, preferably, about 30-400 m²/g, preferably, about 30-300 m²/g, still preferably, about 40-200 m²/g, still preferably, about 180 m²/g. Natural fiber substrate can have a lower BET surface area such as about 2 m²/g, preferably, about 5 m²/g. In another embodiment, the BET surface area of the substrates of the compositions and methods of the current invention is greater than 350 m²/g, preferably about 500 m²/g. Preferably, silica with medium (150 to 350 m²/g) to high (greater or equal to 350 m²/g) BET surface area is useful for the compositions and methods of the current invention. It is believed such silica have better control of water activity and better preservation of CFU. Therefore, in still another embodiment, the substrate is a silica with a BET surface area of 400-600, m²/g, preferably, 500 m²/g. Wherein the compositions or methods of the invention comprise a substrate with a high BET surface area such as SIPERNAT® 50 S silica, said compositions and methods preferably further comprise (i) a polymer selected from the group consisting of polyvinyl alcohol, xanthan gum, gum arabic, or other polysaccharides such as maltodextrin, guar gum (e.g., hydroxypropyl guar gum), polyethylene glycol, and polyglycerol, or (ii) non-reducing disaccharides such as trehalose or sucrose, or (iii) skim milk or dimethyl sulfoxide. Silica of low BET surface area (e.g., 50 to 150 m²/g) are also useful for the compositions of the invention.

Typical pore volume of the substrates of the compositions of the current invention is about 0.01-1.20 cc/g, preferably, about 0.05-1.20 cc/g, still preferably, about 0.10-1.0 cc/g, still preferably, about 0.20-0.95 cc/g. Substrates such as silica having a pore volume of about 0.05-1.20 cc/g, preferably, about 0.10-1.0 cc/g, still preferably, 0.20-0.95 cc/g are useful for the current invention. Substrates such as cellulose having a lower pore volume, such as 0.01-1.2 cc/g are useful for the invention. Such pore volume values are measured based on the Barrett-Joyner-Halenda model. In another embodiment, the substrate of the current invention is a silica with a pore volume of great than 1 cc/g, preferably 1.4 cc/g by Barrett-Joyner-Halenda model or great than 2 cc/g, preferably 2.2 by Mercury Pore Volume.

Substrates disclosed herein provides a suitable surface for the microorganisms to be deposited and dried efficiently in the dryer to achieve a target total water content disclosed herein, avoiding long exposure to heat that lowers organism survival and viable organisms after storage. In particular, the microorganisms are dried onto the surface of said substrate, e.g., using methods disclosed herein to a target total water content of between about 0.01 wt. % and 15 wt. %, in a particular embodiment, between about 0.01 wt. % and about 8 wt. %, preferably, about 5 wt. % and about 8 wt. %, still preferably, about 5 wt. % and about 8 wt. %, still preferably selected from about 3 wt. %, about 5 wt. % and about 7 wt. %. Moisture content level measures the amount of water present in a particular product and may be measured by methods known in the art, for example, by measuring the amount of water (wt. %) lost per gram of product at about 100° C. for a period of time to a constant weight (i.e., loss-on-drying).

The selection of the substrate of the invention together with the target moisture content level provided herein creates an optimum defined water activity (A_{w}) level between about 0.01 and about 0.6, preferably, between about 0.2 and about 0.6, still preferably, between about 0.2 and about 0.5, still preferably, about 0.3 and about 0.5, where, it is believed that the microorganisms are made dormant yet still alive thereby providing a dry and stable system for the delivery of such microorganism without sacrificing viability. Water activity is defined as the ratio of the partial vapor pressure of water in a product to the standard state partial vapor pressure of pure water. Water activity (A_{w}) measures the equilibrium amount of water available for hydration of a particular material (i.e., water availability). Certain substances which have the same moisture content may have different water activity level. Water activity (A_{w}) level may be measured by methods known in the art such as through the use of Resistive Electrolytic Hygrometers (REH), Capacitance Hygrometers and Dew Point Hygrometers.

The current invention allows the microorganism to be concentrated onto the substrate at a high colony-forming unit concentration, in a particular embodiment, the micro-organisms are concentrated on the substrate (particularly silica) in the form of a crust. Therefore, the compositions of the current invention has greater than about 10⁷ CFU/g, preferably, greater than or equal to about 10⁸ CFU/g, still preferably, greater than or equal to about 10⁹ CFU/g, still preferably, greater than or equal to about 10¹⁰ CFU/g, still preferably, greater than or equal to about 10″ CFU/g, still preferably, greater than or equal to about 10¹² CFU/g. The compositions of the current invention are particularly stable, in a specific embodiment, the number of colony forming units per gram of the composition (CFU/g) remains above about 10⁷ CFU/g after storage at room temperature for 120 days, in another embodiment, remains above about 10⁷ CFU/g after storage at 40° C. for 40 days, in still another embodiment, remains above about 10⁷ CFU/g after storage at a relative humidity of 65% or lower for 40 days. In a particular embodiment, the Compositions of the Invention has a loss of CFU of less than 5 log, preferably less than 3 log, more preferably less than 2 log, most preferably less than 1 log over ten weeks at ambient temperature, e.g., 25° C. In another particular embodiment, the Compositions of the Invention has a loss of CFU of less than 5 log, preferably less than 3 log, more preferably less than 2 log, most preferably less than 1 log over ten weeks at ambient temperature (e.g. 25° C.) and elevate humidity, e.g., at 70% relative humidity.

Microorganism useful for the invention include natural or recombinant micro-organisms that act as predators to or intervene with the life cycle of other undesired microorganism, or provide a beneficial effect to the area to be treated, or can produce biologically active substance that are affective as a pesticide. Exemplary microorganisms useful for the invention include those that may be used in the agricultural field, which includes, but are not limited to Bacillus thuringiensis, Pseudomonas fluorescens, Bradyrhizobium, Mycorrhiza, Clonostachys rosea, and the like, or any combinations thereof. Other micro-organisms useful for the invention also include, but are not limited to bacteria such as Bacillus subtilis QST713 and Pasteuria usgae; fungi such as Beauveria bassiana, Coniothyrium minitans, Chondrostereum purpureum, Paecilomyces lilacinus, Aschersonia aleyrodis, Beauveria brongniartii, Hirsutella thompsonii, Isaria fumosorosea, Isaria sp., Lecanicillium longisporum, Lecanicillium muscarium, Lecanicillium sp., Metarhizium anisopliae, Metarhizium anisopliae var. acridum, Nomuraea rileyi and Sporothrix insectorum; viruses such as Cydia pomonella GV; and oomycetes such as Phytophthora palmivora, Lagenidium giganteum, Bacillus spp. and Lactobacillus spp., or any combinations thereof. Further examples of fungi and subspecies useful for the invention may be found in Faria, et al., Biological Control 43 (2007) 237-256, the contents of which are hereby incorporated by reference in their entirety. The current list is not intended to be exhaustive and may include other micro-organisms useful in the agricultural field as well as other fields such as the food, medical or pharmaceutical, detergent and energy sectors.

The substrate-microorganism mixture of the current invention do not require any exogenous protectant such as alginate encapsulation, but may optionally be treated with polymers or other materials such as fumed silica (e.g., Aerosil®) or a combination of polymers and fumed silica to provide additional moisture protection and insulation from high temperature storage. Therefore, in one embodiment, the composition further comprises (i) a polymer selected from the group consisting of polyvinyl alcohol, xanthan gum, gum arabic, or other polysaccharides such as maltodextrin, guar gum (e.g., hydroxypropyl guar gum), polyethylene glycol, and polyglycerol, or (ii) non-reducing disaccharides such as trehalose or sucrose, or (iii) skim milk or dimethyl sulfoxide. In another embodiment, the compositions of the invention further comprise a polymer selected from the group consisting of polyvinyl alcohol, xanthan gum, gum arabic and other polysaccharides such as maltodextrin, guar gum (e.g., hydroxypropyl guar gum), and polyethylene glycol. In still another embodiment, the polymer is polyglycerol, e.g., hyperbranched polyglycerol polymer. In still another embodiment, the composition further comprises non-reducing disaccharides such as trehalose or sucrose. In yet another embodiment, the composition further comprises combination of polymers and a secondary substrate as further described below. The amount of said polymers may be about 0.1-3 wt. %, in a particular embodiment, about 0.1-1 wt. %, in a particular embodiment, about 1-1.5 wt. % of the microorganism suspension. It is noted that the polymer or polysaccharide or non-reducing disaccharide herein may be added before, during or after the drying step (2).

The substrate-microorganism mixture of the current invention may also be treated with a second substrate such as an inorganic material to provide additional moisture protection during storage. In one embodiment, the second substrate is selected from precipitated silica such as SIPERNAT® 50 S silica, e.g., at less than 3% as an outer layer. In another embodiment, the Compositions of the Invention further comprises the addition of a second substrate such as fumed silica such as AEROSIL® 200, AEROSIL® R 972 or AEROSIL® R 812S silica, e.g., at less than 2% as an outer layer. In still another embodiment, the second substrate is a hydrophobic fumed silica having a BET surface area 180 to 220 m²/g and a carbon content of 3.5 to 5% such as AROSIL® R202 silica. The amount of said second substrate may be about 0.1-3 wt. %, in a particular embodiment, about 0.1-1 wt. %, in a particular embodiment, about 0.1 wt. % of the total composition. In a particular embodiment, the Compositions of the Invention comprise microorganism and substrate such as silica having a BET surface area of greater or equal of 350, e.g., BET surface area of 400-600, m²/g, preferably, 500 m²/g, wherein such substrate are coated with one or more (i) polymer selected from the group consisting of polyvinyl alcohol, xanthan gum, gum arabic, or polysaccharides such as maltodextrin, guar gum (e.g., hydroxypropyl guar gum), polyethylene glycol, and polyglycerol, or (ii) non-reducing disaccharides such as trehalose or sucrose, or (iii) skim milk or dimethyl sulfoxide. In yet another embodiment, the Compositions of the Invention comprise one or more microorganisms and a substrate wherein such microorganism-substrate further comprise a secondary substrate (as further described below such as a hydrophobic fumed silica having a BET surface area 180 to 220 m²/g and a carbon content of 3.5 to 5% such as AEROSIL® R202 silica) and optionally one or more (i) polymer selected from the group consisting of polyvinyl alcohol, xanthan gum, gum arabic, or polysaccharides such as maltodextrin, guar gum (e.g., hydroxypropyl guar gum), polyethylene glycol, and polyglycerol, or (ii) non-reducing disaccharides such as trehalose or sucrose, or (iii) skim milk or dimethyl sulfoxide. In still another embodiment, the Compositions of the Invention comprise microorganism, primary silica substrate, secondary silica substrate and one or more polymers from the group consisting of (i) a polymer selected from the group consisting of polyvinyl alcohol, xanthan gum, gum arabic, or other polysaccharides such as maltodextrin, guar gum (e.g., hydroxypropyl guar gum), polyethylene glycol, and polyglycerol, or (ii) non-reducing disaccharides such as trehalose or sucrose, or (iii) skim milk or dimethyl sulfoxide. In still another embodiment, the Compositions of the Invention comprise microorganisms, a hydrophilic silica substrate (e.g., a hydrophilic precipitated silica such as SIPERNAT® 22 silica), a secondary silica substrate (e.g., a hydrophylic or hydrophobic fumed silica such as AEROSIL® R202 or 200 silica) and optionally one or more (i) polymer selected from the group consisting of polyvinyl alcohol, xanthan gum, gum arabic, or polysaccharides such as maltodextrin, guar gum (e.g., hydroxypropyl guar gum), polyethylene glycol, and polyglycerol, or (ii) non-reducing disaccharides such as trehalose or sucrose, or (iii) skim milk or dimethyl sulfoxide. In a particular embodiment, the secondary substrate is added after drying step (2).

The compositions of the current invention may be directly applied to a treatment area such as a plant, a seed or a pest, or they may be formulated into a biological formulation, e.g., for application to such a treatment area. Traditionally, aqueous formulations containing microbes or other biologically active materials are difficult to stabilize within the shelf life of a typical suspension concentrate formulation. The compositions discussed in this invention aim to lower the overall formulation barrier. The current invention teaches the approaches for creating a biological composition with both a higher activity level (CFU) and stability (low change in CFU over time). A more stable composition lowers the formulation hurdles required to generate a usable product that is suitable for use in an agricultural field application. The advantages of the compositions of the invention allow them to be formulated into both liquid and dry agrochemical formulation types. Examples of these formulation include, but not limited to WP (Wettable Powder), WG (Water Dispersible Granule), SC (Suspension Concentrate), OD (Oil Dispersion), FS (Seed Treatment). Therefore, in another aspect, the invention provides a biological formulation comprising the composition of the invention, e.g., Composition I or any of 1.1-1.33 or 1.34-1.50, and one or more excipient. As the microorganism of the invention may be useful for agricultural use, agrochemically acceptable excipients or adjuvants are anticipated such as wetting agents. In addition, combinations with other agrochemical active ingredients may be used.

Water-based formulations of the form SC may include one or more dispersants, polymers, stickers, surfactants, coloring agents, and or anti-freeze compounds. Selection of specific formulation aids are well within the knowledge of one skilled in the art.

Dry formulations include dusts (DP), powders for seed dressing (DS), granules (GR), micro granules (MG), water dispersible granules (WG), wettable powders (WP) and may include one or more binder, dispersant and wetting agents. Selection of specific formulation aids are well within the knowledge of one skilled in the art.

The compositions of the invention are particularly useful in tablet form of the formulation types ST (water soluble tablets) and TB (Tablet). Therefore, in a particular embodiment, the invention provides a biological tablet comprising the composition of the invention, e.g., Composition I or any of 1.1-1.33 or any of 1.34-1.50 and one or more excipient. Excipient useful for the tablet formulation of the invention may comprise one or more lubricant, binder, disintegrant and fillers. Useful lubricant includes, but is not limited to Talc, magnesium stearate, calcium stearate, stearic acid, boric acid, polyethylene glycol and sodium stearyl fumarate. Useful binder includes, but is not limited to microcrystalline cellulose, cellulose acetate, carrageenan, dextrin, glucose, ethyl cellulose, and polyvinylpyrrolidone. Useful filler includes, but is not limited to corn starch, potato starch, sodium starch, glycolate, amylose, primogel, crospovidone and croscarmellose sodium. Useful disintegrant include, but is not limited to calcium silicates. Exemplary tablets can be made with 2 to 30% of miroorganism powder containing 10⁹ CFU per gram of organisms. 2 gram, tablets are compressed at 20KN. The tablets are able to quickly disintegrate using 7.5% of FM1000.

Oil dispersion formulation of the invention comprises the composition of the current invention, e.g., Composition I or any of 1.1-1.33 or any of 1.34-1.50, dispersed in a non-aqueous or water-insoluble liquid such as mineral, paraffinic or vegetable oil and may contain one or more dispersants, emulsifiers polymers, stickers, surfactants. Selection of specific formulation aids are well within the knowledge of one skilled in the art.

Agricultural oils useful for the formulation of the invention include paraffin oils such as octane, nonane, decane, undecane, dodecane, tridecane, tetradecane, pentadecane, hexadecane and mixtures thereof or such oil mixed with higher boiling homologs such as hepta-, octa-, none-decane, eicosane, heneicosane, docosane, tricosane, tetracosane, pentacosane, and the branched chain isomers thereof; vegetable oils such as olive oil, kapok oil, castor oil, papaya oil, camellia oil, palm oil, sesame oil, corn oil, rice bran oil, peanut oil, cotton seed oil, soybean oil, rapeseed oil, linseed oil, tung oil, sunflower oil, safflower oil, or transesterification products thereof, such as rapeseed oil methyl ester or rapeseed oil ethyl ester; animal oil, such as whale oil, cod-liver oil, or mink oil; other oils such as butanol, n-octanol, i-octanol, dodecanol, cyclopentanol, cyclohexanol, cyclooctanol, ethylene glycol, propylene glycol or benzyl alcohol, caproic acid, capric acid, caprylic acid, peiargonic acid, succinic acid, glutaric acid, benzoic acid, toluic acid, salicylic acid and phthalic acid, benzyl acetate, caproic acid ethyl ester, peiargonic acid ethyl ester, benzoic acid methyl or ethyl ester, salicylic acid methyl, propyl, or butyl ester, diesters of phthalic acid with saturated aliphatic, phthalic acid dimethyl ester, dibutyl ester, diisooctyt ester, or any combinations thereof.

The invention also anticipates the composition of the invention for seed treatment or seed dressing. Therefore, in one embodiment, the compositions of the invention provides for a flowable concentrate form, e.g., for seed treatment (FS form), which may be prepared by blending the Composition I or any of 1.1-1.33 or any of 1.34-1.50 with one or more dispersants, film forming polymers, stickers, surfactants, and coloring agents, and adding the blend to a seed. Ingredients to help the formulation stick to the seed, reinforce the coating and reduce dustiness may also be included. Selection of specific formulation aids are well within the knowledge of one skilled in the art.

In another aspect, the invention also provides processes for preparing a dried biological compositions comprising, in a particular embodiment, consisting essentially of, and in another particular embodiment, consisting of the steps of (1) combining a microorganism mixture, solution or suspension with a substrate; and (2) drying the substrate-microorganism mixture to reach a total moisture content of about 0.01 to about 15 wt. %, preferably, about 3 wt. % to about 8 wt. %, still preferably, about 5 wt. % to about 8 wt. %, still preferably selected from 3 wt. %, 5 wt. % and 7 wt. %. In still a further embodiment, step (2) of the process of the current invention dries the composition to a resulting water activity (A_{w}) value of between about 0.01 and about 0.6, preferably, between about 0.2 and about 0.6, still preferably, between about 0.3 and about 0.5.

The microorganisms to be used in the compositions of the current invention may be obtained by various means. In one embodiment, the microorganisms may be harvested from the surface of a seed by washing the seed with water, e.g., 1:1 ratio of water:seed. In another embodiment, the microorganisms may be harvested from the surface of a seed by mechanically grinding or polishing the surface of the seed (step (a)) resulting in a fine fraction containing microorganisms, in a particular embodiment, containing fungal spores, and some parts of the seed. In a particular embodiment, the yield of microorganisms in the fine fraction is greater than 10⁹ cfu/per gram of initially ground or polished seed. In a particular embodiment, the process comprises sieving (step (b)) the resulting fine fraction in order to obtain a powder with a defined particle size distribution for the subsequent process steps. In a particular embodiment, the powder is used to prepare a microorganism mixture, solution or suspension (step c). In a particular embodiment, step (a) comprises grinding with a grinding stone for separating the seed form the fine fraction. In another particular embodiment, step (a) comprises grinding with a rotating shaft inside an enclosing tube of a slotted screen in condition of under pressure with following of a sifter and a filter for separating the seed form the fine fraction. The sieving of the fine fraction step (b) may comprise the sieving with a sieve mesh size of 20 to 800 μm, in a particular embodiment from 100 μm to 300 μm.

In another embodiment, the microorganisms may be harvested from the surface of a seed by washing them off with water and separating the seed and the liquid microorganism solution or suspension. In a particular embodiment, the seed is stirred in water for 1 to 20 min. In another particular embodiment, solid-liquid separation is done in a pressure nutsche filter, in another particular embodiment, the mesh size of 1 to 3 mm is used in the pressure nutsche filter. In another particular embodiment, the dewatering time in the pressure nutsche filter is 20-200 seconds. In a particular embodiment the filtration pressure in the nutsch filter is 1 to 3 bar. In another particular embodiment, the microorganism solution or suspension is concentrated by separating the microorganisms from the liquid in a centrifugal field. In a particular embodiment, the concentration step comprises separation in a disc stack separator. In a particular embodiment, the concentration step is repeated with dilution of the concentrate with water and a subsequent second concentration in a centrifugal field to separate soluble parts from the microorganisms.

The substrate useful for step (1) of the process of the current invention may be selected from the group consisting of silica (e.g., precipitated silica, in a particular embodiment, hydrophilic silica, e.g., SIPERNAT® 22 silica), diatomaceous earth, silica gel, silicates (e.g., aluminosilicates such as ZEOLEX® 301, or clays) and water-insoluble natural fiber material such as cellulose. In one embodiment, the substrate of step (1) of the process of the invention is silica, in a further embodiment, precipitated silica, e.g., wherein the particle size (d50) of the substrate is about 5-200 microns, preferably, about 8-160 microns, still preferably, about 9-150 microns, still preferably, about 50-150 microns, still preferably, about 50-130 microns, still preferably, selected from a group consisting of about 50 microns, about 85 microns and about 120 microns. In another further embodiment, the substrate of step (1) of the process of the current invention is precipitated hydrophilic silica. In a further embodiment, said silica of step (1) of the process of the current invention has (i) a BET surface area about 2-600 m²/g, in a further embodiment, 500 m²/g, in another further embodiment, 2-400 m²/g, preferably, about 5-400 m²/g, still preferably, about 10-400 m²/g, still preferably, about 30-400 m²/g, still preferably, about 30-300 m²/g, still preferably, about 40-200 m²/g, still preferably, about 180 m²/g; and/or (ii) pore volume of about 0.01-1.20 cc/g, preferably, about 0.05-1.20 cc/g, still preferably, about 0.10-1.0 cc/g, still preferably, about 0.20-0.95 cc/g by Barrett-Joyner-Halenda model; and/or (iii) pore volume of great than 1 cc/g, preferably 1.4 cc/g by Barrett-Joyner-Halenda model or great than 2 cc/g, preferably 2.2 by Mercury Pore Volume. In a further embodiment, the substrate of step (1) is selected from SIPERNAT® 22 or SIPERNAT® 50 S silica.

The Process of the current invention described herein may further comprise adding after step (1), but in one embodiment, before step (2), in another embodiment, during step (2) and in still another embodiment, after step (2), (i) a polymer selected from the group consisting of polyvinyl alcohol, xanthan gum, gum arabic, or other polysaccharides such as maltodextrin, guar gum (e.g., hydroxypropyl guar gum), polyethylene glycol, and polyglycerol, or (ii) non-reducing disaccharides such as trehalose or sucrose, or (iii) skim milk or dimethyl sulfoxide, in a particular embodiment polyvinyl alcohol or polyglycerol (e.g., hyperbranched polyglycerol); and/or (ii) a secondary substrate as an outer layer. In a particular embodiment, the secondary substrate is selected from a precipitated silica such as SIPERNAT® 50 S silica, or a fumed silica such as AEROSIL® 200, AEROSIL® R 972, AEROSIL® R 812S or AEROSIL® 202, preferably AEROSIL® 200 or R202, more preferably AEROSIL® R202 silica. The polymer disclosed herein may be added without the secondary substrate. In another embodiment, the polymer disclosed herein may be added with the secondary substrate and can be added before or after the secondary substrate. The polymer and/or the secondary substrate may be added before drying step (2) or during drying step (2) or after drying step (2).

Drying step (2) of the process of the invention may be achieved by fluid bed drying, spray drying, contact drying or freeze drying. Fluid bed drying may be achieved by allowing the inlet air temperature to be less than or equal to about 90° C., preferably, less than or equal to about 80° C., preferably, less than or equal to about 50° C., still preferably, at about 30°−50° C., still preferably, at about 40°-50° C., still preferably, at about 40°-45° C., still preferably, at about 43° C. In a particular embodiment, the drying step (2) of the process of the invention may be achieved by preheating the spray dryer with a very low fan speed with an air temperate to inlet air temperature of less than or equal to about 50° C., preferably, at about 30°−50° C., still preferably, at about 40°−50° C., still preferably, at about 40°-45° C. and spraying the micro-organism mixture into the chamber onto the substrate. Preferably, the pumping speed on a laboratory scale is 1 mL/min, still preferably, 2 mL/min of substrate. Optionally, drying step (2) also includes drying at reduced pressure (e.g., at 0.1 bar).

Spray drying may be achieved by allowing the inlet air temperature to be less than or equal to about 130° C., preferably, less than or equal to 110° C., still preferably less than or equal to 100° C., still preferably, less than or equal to about 90° C., still preferably, less than or equal to about 80° C., still preferably, less than or equal to about 50° C., still preferably, at about 30°−50° C. The spray drying may be with gas flow.

Preferably, drying step (2) of the process of the invention comprises maintaining the powder bed temperature of less than or equal to about 35° C., preferably, less than or equal to about 30° C., still preferably, between about 25° C. and 35° C.

It is believed that the drying time is proportional to the surface area of the silica and the control of water activity is inversely proportional to surface area of the silica. Therefore, in an embodiment, silica with medium (such as 150 to 350 m²/g) to high (great than 350 m²/g such as 400-600 m²/g, e.g., 500 m²/g) BET surface area yield better control of water activity and better preservation of cfu. In another embodiment, use high (great than 350 m²/g such as 400-600 m²/g, e.g., 500 m²/g) BET surface area silica with humectants or polymers or polysaccharides also yield good control of water activity and preservation of cfu for a long amount of time. Preferably, silicas with high BET surface area are dried under shorter time and hi temperature, e.g., using a spray drying at 100° C. for short amount of time (e.g., residence time of 2-80 seconds).

The microorganism mixture or solution or suspension of step (1) of the process of the invention may be fermented in a stirred batch fermenter by adding sugars and other nutrients into a batch reactor that is either aerated or maintained in an anaerobic state to allow the organisms to multiply and reach an optimum state for harvest depending on the nature of the organism. In another aspect, organisms may be grown on solid media such as cellulosic material, seeds, and other solid materials suspended in a stirred reactor. In yet another aspect, the microorganisms may be grown on solid medium in a dry, but humidified environment, washed from the seeds when optimal.

For purposes of this application, AEROSIL® 200 silica refers to a hydrophilic silica having a BET surface area of 200 m²/g. AEROSIL® R 202, R 972, R 812 refer to hydrophobic fumed silica.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrases “at least one of A, B, . . . and N” or “at least one of A, B, . . . N, or combinations thereof” are defined in the broadest sense to mean one or more elements selected from the group comprising A, B, . . . and N, that is to say, any combination of one or more of the elements A, B, . . . or N including any one element alone or in combination with one or more of the other elements which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

### EXAMPLES

The foregoing may be better understood by reference to the following examples, which are presented for purposes of illustration and are not intended to limit the scope of the invention.

### Examples 1-10

Fluid Bed Dried Composition of the Invention: About 50 grams of a suspension drained from a 1:1 water rinse of seeds containing Chlonostachys Rosea is sprayed on to about 25 grams of substrate in a fluid bed dryer. The pump speed, atomizing air pressure and fan speed is adjusted accordingly (e.g., at 1 mL/min pump speed and 0.1 bar of atomizing air pressure) so as to allow the substrate-spores to be dried at an inlet temperature of about 45° C. and the powder bed temperature of less than 28° C. Samples are heated until the desired moisture measurement is achieved. The samples are analyzed using the below methods.

Dry Particle Size Test. Substrate particle size measurement is conducted on HORIBA Laser Scattering Dry Particle Size Distribution Analyzer LA-950 through the angle of scattered laser light.

Total Moisture Content Measurements. Dried substrate-microorganism powder moisture measurement is conducted on Satorius Moisture Balance. A mass of 0.1 g of the sample powder is weighed and kept in a aluminum plate. Three replicates are done while heating the sample to a temperature of 105° C. to constant weight, usually 2 mins.

Water Activity. Water activity (A_{w}) of test samples are measured by placing the sample in a water activity measuring device which consists of a mirror above the test sample in a closed sample chamber. When the relative humidity reaches equilibrium, the mirror is chilled until condensation forms on the mirror due to the dew point. That temperature can be calculated as the water activity level.

Scanning Electron Microscope (SEM) image. A Hitachi TM 3000 electron microscope is used to obtain images of the substrate-microorganisms of the invention to show the morphology and composition of the product particles. The images show that spores cells are attached onto the silica particles.

Mercury Pore Volume and Pore Diameter Test The mercury intruded pore volume (Hg) is measured by mercury porosimetry using a Micromeritics AutoPore IV 9520 apparatus. The pore diameters can be calculated by the Washburn equation employing a contact angle, Theta (0) equal to 130° and a surface tension, gamma equal to 485 dynes/cm. Mercury is forced into the voids of the particles as a function of pressure and the volume of the mercury intruded per gram of sample is calculated at each pressure setting. The pore volume expressed herein represents the cumulative volume of mercury intruded at pressures from 171 to 18000 psia. The intruded mercury at these pressures corresponds to a pore diameter of from 1000 to 10 nm. Increments in volume (cm3/g) at each pressure setting are plotted against the pore diameter corresponding to the pressure setting increments. The peak in the intruded volume versus pore radius or diameter curve corresponds to the mode in the pore size distribution and identifies the most common pore size in the sample. Specifically, sample size is adjusted to achieve a stem volume of 25-75% in a powder penetrometer with a 5 mL bulb and a stem volume of about 1.1 mL. Samples are evacuated to a pressure of 50 μm of Hg and held for 5 minutes. Mercury fills the pores from 1.5 to 60,000 psia with a 10 second equilibrium time at each of approximately 103 data collection points.

BET Surface Area and Pore Volume The BET surface areas of the substrates (e.g., silica or silicate particles) is determined with a Micromeritics TriStar 3020 instrument by the BET nitrogen adsorption method of Brunaur et al., J. Am. Chem. Soc., 60, 309 (1938), which is known in the field of particulate materials, such as silica and silicate materials. Nitrogen adsorption-desorption isotherms were collected at 77K. Powdered samples of 50-100 mg are degassed at 105° C. for 2 hours prior to measurement. Barrett-Joyner-Halenda (BJH) models are used to calculate pore volume and BET surface area. Total pore volume calculations are taken from the total quantity of nitrogen adsorbed at a partial pressure (P/Pₒ) of 0.99.

CFU testing. The concentration of the microorganisms is determined by plate count using serial dilution techniques. The microorganism-substrate powder is stirred in sterile water with Triton surfactant present to mobilize the microorganisms. The resulting suspension of microorganisms is sequentially diluted several times each time by a factor of 10. Each time a sample of the dilution is plated onto sterile agar plates and incubated. After several days the organisms present can be seen as dots on the agar. When the dilution is sufficient to reduce the number on the plate to a countable quantity, the number of colonies are counted and multiplied by the dilution factor to determine the population in the original population.

Using the analytical methods described or similarly described above, the physical properties of various substrates are measured and summarized below in table 1.

TABLE 1

| | | | Pore | | |
|---|---|---|---|---|---|
| | | BET | Volume | Pore Volume | Particle |
| | Substrate | Surface | BJH | Hg 10-1000 nm | size |
| Substrates | Type | Area m²/g | cc/g | cc/g | microns |
| SIPERNAT ® 50 silica | silica | 500 | 1.40 | 2.24 | 50 |
| ZEOFREE ® 5161A silica | silica | 160 | 0.60 | 2.37 | 85 |
| SIPERNAT ® 22 silica | silica | 180 | 0.92 | 1.98 | 120 |
| SIPERNAT ® 22 silica | silica | 180 | 0.92 | 1.98 | 120 |
| SIPERNAT ® 22 silica | silica | 180 | 0.92 | 1.98 | 120 |
| ZEOLEX ® 201 silicate | silicate | 75 | 0.20 | 1.45 | 14 |
| ZEODENT ®116 silica | silica | 55 | 0.24 | 1.20 | 9 |
| ZEODENT ® 103 silica | silica | 38 | 0.15 | 0.52 | 8 |

Using the methods described or similarly described above, the total moisture content and water activity (A_{w}) level of the test samples after fluid bed drying are measured and summarized in Table 2; the BET surface area, time of drying, final moisture content, water activity (A_{w}) and initial CFU of the test samples are reported in Table 3; the water activity (A_{w}) vs moisture content effect on CFU/g after 5 months at 25° C. is summarized in Table 4.

TABLE 2

| | | Total | | | |
|---|---|---|---|---|---|
| | | Moisture | Water | Water Activity | |
| | | Content | Activity | Temperature | |
| Example | Substrate | (%) | (A_{w}) | (° C.) | Drying method |
| 1 | SIPERNAT ® 50 | 55 | 0.941 | 20.8 | Fluid bed dried |
| 2 | SIPERNAT ® 22 | 3.1 | 0.288 | 20.8 | Fluid bed dried |
| 3 | SIPERNAT ® 22 | 2.7 | 0.327 | 20.8 | Fluid bed dried |
| 4 | SIPERNAT ® 22 | 3.96 | 0.348 | 20.8 | Fluid bed dried |
| 5 | SIPERNAT ® 22 | 5.14 | 0.385 | 20.7 | Fluid bed dried |
| 6 | SIPERNAT ® 22 | 9.04 | 0.688 | 20.8 | Fluid bed dried |
| 7 | ZEOFREE 5161A | 7 | 0.545 | 20.7 | Fluid bed dried |

TABLE 3

| | | Pore | Pore | Total | | | Inlet | | |
|---|---|---|---|---|---|---|---|---|---|
| | | Volume | Volume Hg | Moisture | Drying | Water | Air | | |
| | | BJH | 10-1000 nm | Content | time | Activity | Temp | Initial | Drying |
| Ex. | Substrate | (cc/g) | (cc/g) | (%) | (min) | (A_{w}) | (° C.) | CFU/g | Method |
| 1 | SIPERNAT ® 50 | 1.40 | 2.24 | 55 | 60 | 0.94 | 45 | 1 × 10⁶ | Fluid |
| | (silicon dioxide) | | | | | | | | bed dried |
| 2 | SIPERNAT ® 22 | 0.92 | 1.98 | 3.1 | 40 | 0.288 | 45 | 1.9 × 10⁹ | Spray |
| | (silicon dioxide) | | | | | | | | dried |
| 7 | ZEOFREE ® | 0.60 | 2.37 | 7.00 | 35 | 0.55 | 45 | 1 × 10⁷ | Fluid |
| | 5161A | | | | | | | | bed dried |
| | (silicon dioxide) | | | | | | | | |
| 8 | ZEOLEX ® 201 | 0.20 | 1.45 | 6.8 | 33 | 0.581 | 45 | 2.9 × 10⁷ | Fluid |
| | (sodium | | | | | | | | bed dried |
| | aluminosilicate) | | | | | | | | |
| 9 | ZEODENT 116 | 0.24 | 1.20 | 8.64 | 28 | 0.280 | 45 | 2.8 × 10⁷ | Fluid |
| | (silicon dioxide) | | | | | | | | bed dried |
| 10 | ZEODENT 103 | 0.15 | 0.52 | 8.67 | 17 | 0.384 | 45 | 1.9 × 10⁸ | Fluid |
| | (silicon dioxide) | | | | | | | | bed dried |

TABLE 4

| | | Total | | | CFU/g after |
|---|---|---|---|---|---|
| | | Moisture | Water | Inlet Air | storage for 5 |
| | | Content | Activity | Temp. | months at |
| Example | Substrate | (wt. %) | (A_{w}) | (° C.) | 25° C. |
| 1 | SIPERNAT ® 50 | 55 | 0.941 | 45 | ~10¹ |
| 2 | SIPERNAT ® 22 | 3.1 | 0.288 | 45 | 1 × 10⁹ |
| 5 | SIPERNAT ® 22 | 5.14 | 0.385 | 45 | 7.2 × 10⁵ |
| 6 | SIPERNAT ® 22 | 9.04 | 0.688 | 45 | ~10¹ |
| 7 | ZEOFREE 5161A | 7 | 0.545 | 45 | 1.5 × 10⁶ |

As can be seen from the tables above, the substrate with high BET surface area and larger pore volume such as SIPERNAT® 50 surprisingly does not dry as quickly in a fluid bed dryer, resulting in exposing the organisms to excessive amounts of time in the dryer. Substrates with lower BET surface area and pore volume are dried faster in a fluid bed dryer, which allows less stress on the organisms, and higher CFU/g after drying, which can result in a potential cost savings per CFU/g due to lower drying costs. Table 4 also shows that the higher the total moisture content, the bigger the drop in CFU/g during storage. The silica must maintain low moisture during storage to maintain high CFU/g. The current invention therefore shows that the selection of substrates with optimal BET surface area and pore volume results in low total moisture content with fast drying time which creates less stress on the microorganisms and therefore yields high initial CFU/g and also allows for higher CFU/g values after 5 months.

### Example 11

Spray Dried Composition of the Invention: Bacterial biomass of Pseudomonas fluorescens is harvested from overnight culture in a shake flask by centrifugation at 8000 g for 10 minutes. The cell pellet is re-suspended in a sodium chloride solution (0.9% w/w), and added to a suspension of the Sipernat® 50 silica substrate and gum arabic. The resulting suspension has approximately 8% Silica, 7% gum arabic, 3% dry biomass and 81% water. The suspension is then spray dried in a Büchi B-290 laboratory spray dryer at a gas inlet temperature of 78° C. Spraying is done using a two-fluid-nozzle at an atomizing pressure of approximately 1.35 bar. The flow rate of the drying air is 38 m³/h. The spraying rate is approximately 5 mL/min. The set parameters result in an outlet temperature of 53° C. and a residual moisture of 6.3% of the product. The cfu count in the resulting powder is 3.4×10⁷ cfu/g.

Aqueous harvest of fungal spores: Washing of 15 g of initial seeds with fungal spores on the surface is carried out with water, the mass of water is 3-10 times the mass of the seeds. The resulting suspensions are filtered through a mesh of 3 mm after mixing with a stirrer (disk stirrer) and a mixing time of 20 min. The suspension is filtered using a 380 ml laboratory pressure nutsche. The operating conditions are at room temperature and 1 bar (abs). The time for dewatering is 120 seconds. The filtrate is analyzed via spore count analysis. Further concentration of the filtrate is achieved by separation in a laboratory centrifuge at 2100 g for 5 minutes for reducing the water content before utilization in fluidized bed spraying.

Dry harvest of fungal spores: 100 g of seeds with fungal spores on the surface are ground in a grinding machine with a rotating grinding stone for a residence time of 20 seconds. A fine fraction is generated due to grinding of the surface of the seeds and is collected separately from the residues of the seeds, weighed and the number of cfu in the sample is determined. The reached cfu in the fine fraction is 5×10⁹ cfu per gram of seeds. The resulting fine fraction is sieved with a 300 μm mesh sieve. The resulting powder is mixed with water to obtain a suspension for subsequent spraying and drying in a fluidized bed.

### Examples 12-23

The Examples below are carried out to determine the effect of additives on improving the thermal and humidity stability of microorganisms.

Washing Procedure. Seeds are washed by mixing the seeds with an equal mass of water until the water turned a light brown color. The spore suspension is strained from the seeds until half the initial volume of water is collected, more water is added if necessary to collect the final volume, which includes added volume from stock solutions. Additive are mixed directly into the suspension (AEROSIL® 200 silica and HPG) or in a concentrated stock solution (PVA) to 2% gram to final volume (mL).

Fluid Bed Drying. Spore suspension collected is sprayed at approximately 4 g/min. from above onto SIPERNAT® 22 silica at equal the weight of suspension sprayed. Fan speed 8 Hz, Inlet air temp is set to 45° C. for samples without additive in the suspension and 55° C. for samples with additive(s). Powder temperature starting temperature 28° C. Powder is considered dry when the temperature rapidly increased from the starting temperature (28° C.) after some minutes indicating dryness.

CFU Count. CFU, or colony forming unit, is the number of viable spores on one gram of product. The spore powder is mixed with Triton solution and by serial dilution method and plating on Potato Dextrose agar with 0.1% streptomycin incubated at room temperature for 5 days. The CFU is determined by counting the plate with 30-300 spores multiplied by the dilution factor.

Post-Addition of AEROSIL® R 202 silica. AEROSIL® R 202 silica is added to the final powder at 1% g/g for select samples. This is mixed in the turbula, a low energy mixer, for 5 minutes to evenly coat the spore powder.

Thermal Stability. Spore powder with a sufficiently low water activity is stored in an oven at 40° C., CFU is counted on at various time points to measure the decline of viable cell density on the powder.

Humidity Stability. Spore powder is stored in a humidity chamber (Associated Environmental Systems) at 70% relative humidity at 25° C. in Tubulin semiporous bags, which are permeable to water vapor and not spores. CFU is measured at various time points to measure progress.

Water Activity. Water activity is defined as the vapor pressure of water in a closed sample. This is measured by the dew point on a chilled mirror in a sealed chamber as the temperature of the mirror drops. Water activity is measured on an AquaLab model 3.

Decimal Reduction Time. The decimal reduction time is defined as the time to reduce the viable population of microbes by 90%. It is calculated using the inverse slope of the survival curve, which is a plot of log CFU over time.

Results. The Samples used in the stability experiments are initially screened to have both a high CFU and low water activity. Samples that did not meet these requirements are discarded and remade. The water activity of each sample used can be seen in Table 6 below. Samples that had these two requirements are split and half mixed with AEROSIL® R 202 silica. The resulting powders are then either stored in an oven at 40° C. or in a humidity chamber at 25° C./70% relative humidity.

Table 5 below summarizes the preparation of the samples:

| Examples | Additive(s) | Description |
|---|---|---|
| 12 | — | Spore suspension is sprayed onto SIPERNAT ® 22 |
| 13 | AEROSIL ® 200 silica | 2% AEROSIL ® 200 silica is added to spore |
| | | suspension and sprayed onto SIPERNAT ® 22 |
| 14 | HPG | 2% HPG is added to spore suspension and sprayed |
| | | onto SIPERNAT ® 22 silica |
| 15 | PVA | 2% PVA is added in spore suspension and sprayed |
| | | onto SIPERNAT ® 22 silica |
| 16 | AEROSIL ® R 202 silica | Sample 12 is mixed with 1% AEROSIL ® R 202 |
| | | silica (for thermal stability test) |
| 17 | AEROSIL ® 200 & AEROSIL ® | Sample 13 mixed with 1% AEROSIL ® R 202 silica |
| | R 202 silica | (for thermal stability test) |
| 18 | HPG & AEROSIL ® R 202 | Sample 14 mixed with 1% AEROSIL ® R 202 silica |
| | silica | (for thermal stability test) |
| 19 | PVA & AEROSIL ® R 202 silica | Sample 15 mixed with 1% AEROSIL ® R 202 silica |
| | | (for thermal stability test) |
| 20 | AEROSIL ® R 202 silica | Sample 12 mixed with 1% AEROSIL ® R 202 silica |
| | | (for humidity stability test) |
| 21 | AEROSIL ® 200 & AEROSIL ® | Sample 13 mixed with 1% AEROSIL ® R 202 silica |
| | R 202 silica | (for humidity stability test) |
| 22 | HPG & AEROSIL ® R 202 | Sample 14 mixed with 1% AEROSIL ® R 202 silica |
| | silica | (for humidity stability test) |
| 23 | PVA & AEROSIL ® R 202 silica | Sample 15 mixed with 1% AEROSIL ® R 202 silica |
| | | (for humidity stability test) |

TABLE 6
Samples and corresponding initial water activities.

| Examples | Additives | Water Activity |
|---|---|---|
| 12 | — | 0.121 |
| 13 | 2% AEROSIL ® 200 silica | 0.165 |
| 14 | 2% HPG | 0.25 |
| 15 | 2% PVA | 0.15 |

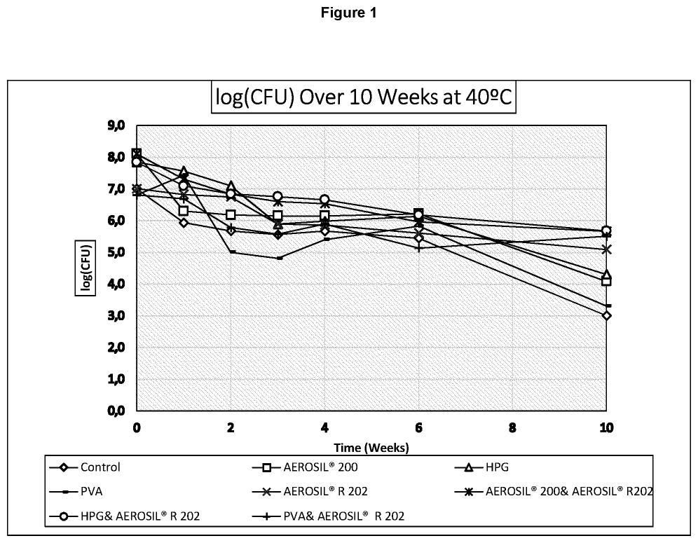

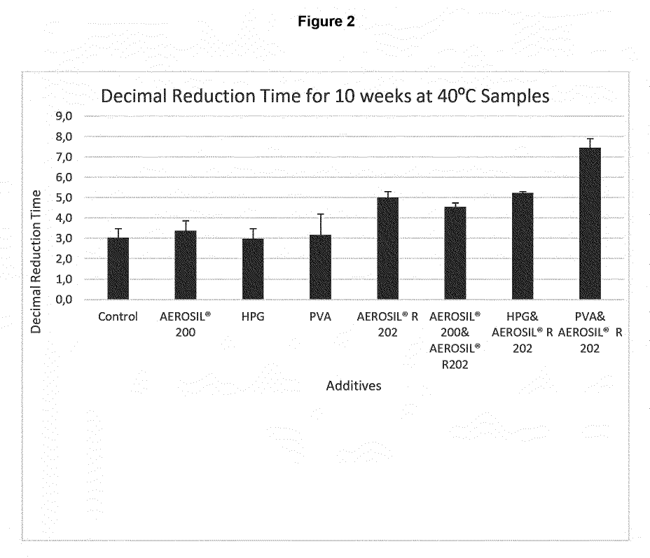

Samples tested for thermal stability are stored in an oven monitored over a 10 week period. CFU is measured at several time points, as shown in FIG. 1. The decimal reduction time (D-value) is calculated and can be seen in FIG. 2. As can be seen, for the first six weeks, the values did not diverge significantly. At the 10-week mark, however, samples that are mixed with AEROSIL® R 202 silica are seen to be more stable than those without. Samples that are not post-treated with AEROSIL® R 202 silica has a low CFU value at this time point, too low to be very accurately counted. This shows that the addition of AEROSIL® R 202 silica helps to improve the stability of the spore powder and extends the shelf-life of the powder. The combination of PVA and AEROSIL® R 202 silica is the most stable long-term. PVA, however, has a lower initial CFU. While some of this can be attributed to variations in processing, the spore suspension is also more diluted because PVA is difficult to dissolve and therefore added to the spore suspension as a concentrated stock solution.

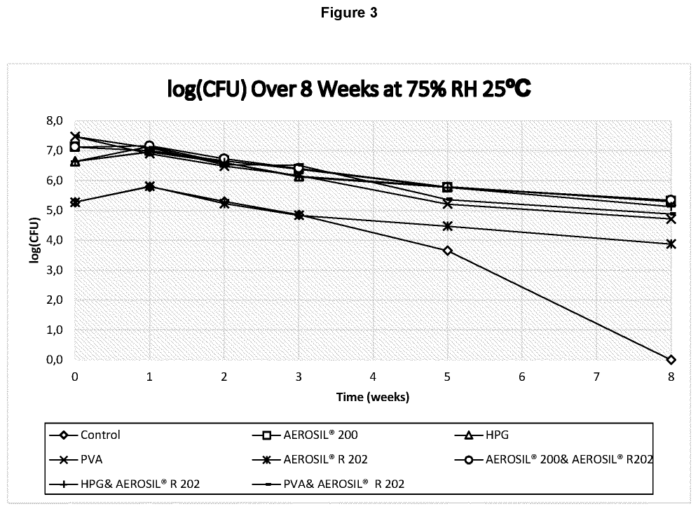

While most samples show comparable trends, the control performs the worst in the thermal stability tests. The sample without any additives also starts with the lowest CFU. The sample with only AEROSIL® R 202 silica also starts with a low CFU; however, it performs much better stability-wise. These trends in CFU can be seen in FIG. 3.

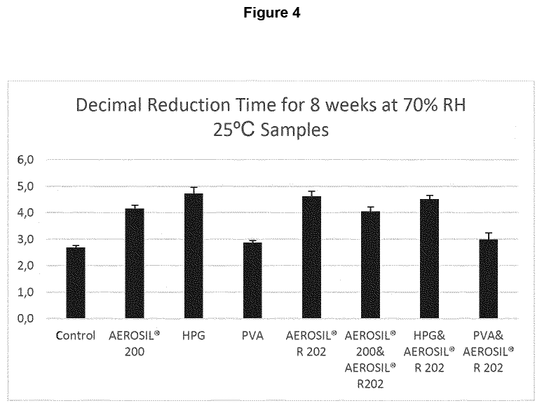

As shown in FIG. 4, samples containing HPG perform the best. The sample with only AEROSIL® R 202 silica also has a similar decimal reduction time. Samples with additives mixed into the spore solution (AEROSIL® 200 silica, HPG, PVA) do not show any further improvement when post-mixed with AEROSIL® R 202 silica. While AEROSIL® R 202 silica does improve humidity stability as compared to the control, it does not further improve humidity stability when used in addition to other additives. It is believed that the samples with additives are able to better keep moisture away from the spores under humid conditions.

The post-addition of AEROSIL® R 202 silica shows clear improvement in thermal stability as compared to samples without. Similarly, AEROSIL® R 202 silica has also improved humidity stability, but does not further improve humidity stability when used in conjunction with other additives. Therefore, adding AEROSIL® R 202 silica is the most effective way to improve long-term thermal and humidity stability.

Examples 24-25 are prepared as described below:

### Example 24

| | Wt. % | Wt. % |
|---|---|---|
| Ingredients | Dispersion | Product |
| Sipernat ® 50 silica | 8 | 32 |
| Gum Arabic | 7 | 28 |
| Trehalose | 5 | 20 |
| Pseudomonas fluorescens | 3 | 20 |
| Sodium chloride solution (0.9% w/w) | 77 | 0 |

### Example 25

| | Wt. % | Wt. % |
|---|---|---|
| Ingredients | Dispersion | Product |
| Sipernat ® 50 silica | 4 | 17 |
| Gum Arabic | 4 | 15 |
| Trehalose | 9 | 34 |
| Pseudomonas fluorescens | 8 | 34 |
| Sodium chloride solution (0.9% w/w) | 75 | 0 |

Biomass of Pseudomonas fluorescens is fermented in minimal medium and harvested using a disk centrifuge to obtain a concentrated cell suspension. A physiological saline solution is prepared and mixed with trehalose, gum arabic as well as Sipernat® 50 silica. The harvested cell suspension is mixed with the trehalose/gum Arabic/Sipernat® silica suspension. The components of the suspension of Example 24 after mixing amount to 8% Silica, 7% gum arabic, 3% dry biomass, 77% sodium chloride solution as well as 5% trehalose. The components of the suspension of Example 25 amount to 4% Silica, 4% gum arabic, 8% dry biomass, 75% sodium chloride solution as well as 9% trehalose. The suspensions of Example 24 and Example 25 are separately spray dried in a Niro Minor spray dryer using a two-fluid-nozzle at an atomizing pressure of 2.3 bar. The gas inlet temperature is 100° C. and the mass flow rate of the suspension is 0.9 kg/h for Example 24 and the gas inlet temperature is 110° C. and the mass flow rate of the suspension is 1.6 kg/h for Example 25. This resulted in an outlet temperature of 50° C. for both Examples 24 and 25. The gas flow of the drying gas is 45 m³/h for both Examples 24 and 25. The moisture content of the product for Examples 24 and 25 are 7 wt. % and 0.3 water activity. The cfu of the final product of Example 24 is 2×10¹⁰ cfu/g, of Example 25 is 3.6×10¹⁰ cfu/g.

1. A dried biological composition, comprising:
(1) a substrate; and
(2) micro-organisms loaded onto the surface of the substrate,
wherein the composition has a total moisture content in a range of from 0.01 to 15 wt. %.

2. The composition of claim 1, wherein the composition has a water activity value (Aw) in a range of from 0.01 to 0.6.

3. The composition of claim 1, wherein the composition has greater than 107 CFU/g.

4. The composition of claim 1, wherein the substrate is selected from the group consisting of silica, diatomaceous earth, silica gel, silicates, and water-insoluble natural fiber material.

5. (canceled)

6. The composition of claim 1, wherein the substrate is precipitated silica.

7. (canceled)

8. The composition of claim 1, wherein a particle size (d50) of the substrate is in a range of from 5 to 200 microns.

9. The composition of claim 1, wherein a BET surface area of the substrate is in a range of from 2 to 600 m²/g.

10-11. (canceled)

12. The composition of claim 1, wherein a pore volume of the substrate is in a range of from 0.01 to 1.20 cc/g, based on the Barrett-Joyner-Halenda model, or
wherein a BET surface area of the substrate is in a range of from 400 to 600 m²/g, and with a pore volume of greater than 1 cc/g, by Barrett-Joyner-Halenda model or greater than 2 cc/g by Mercury Pore Volume.

13. The composition of claim 1, wherein a final microorganism concentration is in a range of from 4 to 40 wt. %, based on total composition weight.

14. The composition of claim 1, wherein the micro-organisms are selected from the group consisting of Bacillus subtilis QST713, Pasteuria usgae; Beauveria bassiana, Coniothyrium minitans, Chondrostereum purpureum, Paecilomyces lilacinus, Aschersonia aleyrodis, Beauveria brongniartii, Hirsutella thompsonii, Isaria fumosorosea, Isaria sp., Lecanicillium longisporum, Lecanicillium muscarium, Lecanicillium sp., Metarhizium anisopliae, Metarhizium anisopliae var. acridum, Nomuraea rileyi Sporothrix insectorum; Cydia pomonella GV; Phytophthora palmivora, Lagenidium giganteum, Bacillus thuringiensis, Pseudomonas fluorescens, Bradyrhizobium, Mycorrhiza, Clonostachys rosea, Bacillus spp. and Lactobacillus spp., and a combination thereof.

15. The composition of claim 1, wherein the micro-organisms are Clonostachys rosea or Pseudomonas fluorescens.

16. The composition of claim 1, in tablet form, flowable concentrate form, or in oil dispersion form further comprising one or more excipient.

17. The composition of claim 1, not requiring exogenous protectant.

18. The composition of claim 1, further comprising:
(i) a polymer selected from the group consisting of polyvinyl alcohol, xanthan gum, gum arabic, a different polysaccharide, polyethylene glycol, and polyglycerol; or
(ii) non-reducing disaccharide; or
(iii) skim milk or dimethyl sulfoxide.

19. The composition of claim 1, further comprising:
a second substrate as an outer layer, preferably, the second substrate is selected from (i) a precipitated silica and (ii) a fumed silica.

20. The composition of claim 1, wherein a number of colony forming units per gram of the composition (CFU/g) remains above 107 CFU/g after storage at:
(a) room temperature for 120 days;
(b) 40° C. for 40 days; and/or
(c) a relative humidity of 65% or lower for 40 days.

21. The composition of claim 1, having a tap density greater than 150% of a tapped density of a pure substrate material.

22. A process for preparing a dried biological composition, the method comprising:
(1) combining a micro-organism mixture, solution, or suspension with a substrate, to obtain a substrate-microorganism mixture; and
(2) drying the substrate-microorganism mixture to reach a total moisture content in a range of from 0.01 to 15 wt. %.

23. The process of claim 22, wherein the microorganisms are harvested from a surface of a seed by (a) mechanically grinding or polishing the surface of the substrate resulting in a fine fraction including microorganisms and some parts of the seed; and optionally (b) sieving the resulting fine fraction in order to obtain a powder with a defined particle size distribution for subsequent processing.

24. The process of claim 23, wherein the mechanically grinding or polishing (a) comprises grinding the seed with a grinding stone to separate the seed from the fine fraction

25. The process of claim 23, wherein the mechanically grinding or polishing (a) comprises grinding with a rotating shaft inside an enclosing tube of a slotted screen at an under pressure, followed by contacting with a sifter and a filter to separate the seed form the fine fraction.

26. The process of claim 23, wherein the sieving (b) of the fine fraction is conducted and comprises sieving with a sieve mesh size in a range of from 20 to 800 μm.

27. The process of claim 22, wherein the microorganisms are harvested from a surface of a seed by washing them off with water and separating the seed and a liquid microorganism solution or suspension.

28. The process of claim 22, wherein drying (2) comprises fluid bed drying, spray drying, contact drying, or freeze drying the substrate-microorganism mixture.

29-31. (canceled)

32. The process of claim 22, wherein a drying air temperature is less than or equal to 130° C.

33. The process of claim 22, wherein a powder bed is maintained at less than or equal to 35° C.

34. The process of claim 22, wherein the resulting composition has a water activity value (Aw) in a range of from 0.01 to 0.6.

35. The process of claim 22, wherein a resulting composition from the drying has a colony-forming units of microorganisms per gram of composition greater than 107 CFU/g.

36. The process of claim 22, wherein the substrate is selected from the group consisting of silica, diatomaceous earth, silica gel, silicates, and water-insoluble natural fiber material.

37. The process of claim 22, wherein the substrate is silica.

38. The process of claim 22, wherein the substrate has a BET surface area in a range of from 400 to 600 m²/g by Barrett-Joyner-Halenda model, and the pore volume of great than 1 cc/g by Mercury Pore Volume.

39. The process of claim 22, wherein the substrate is selected from those having:
(i) a particle size (d50) in a range of from 5 to 200 microns;
(ii) a BET surface area in a range of from 2 to 400 m²/g;
(iii) a pore volume of the substrate is in a range of from 0.01 to 1.20 cc/g;
(iv) or any combination thereof.

40. The process of claim 22, wherein the combining (1) comprises loading an amount in a range of from 4 to 40 wt. %, of the total composition.

41. The process of claim 22, wherein micro-organisms are selected from the group consisting of Bacillus subtilis QST713, Pasteuria usgae; Beauveria bassiana, Coniothyrium minions, Chondrostereum purpureum, Paecilomyces lilacinus, Aschersonia aleyrodis, Beauveria brongniartii, Hirsutella thompsonii, Isaria fumosorosea, Isaria sp., Lecanicillium longisporum, Lecanicillium muscarium, Lecanicillium sp., Metarhizium anisopliae, Metarhizium anisopliae var. acridum, Nomuraea rileyi Sporothrix insectorum; Cydia pomonella GV; Phytophthora palmivora, Lagenidium giganteum, Bacillus thuringiensis, Pseudomonas fluorescens, Bradyrhizobium, Mycorrhiza, Clonostachys rosea, Bacillus spp., Lactobacillus spp., and a combination thereof.

42. The process of claim 22, wherein the resulting composition does not require exogenous protectant.

43. A dry biological composition, prepared by the process of claim 22.

44. The composition claim 1, further comprising:
a seed to be treated.

45. A method for controlling insect, fungus, or nematode on an area to be treated, the method comprising:
optionally reconstituting the dry biological composition of claim 1, and
applying an effective amount of the optionally reconstituted composition to the area to affect treatment.

46. The method of claim 45, wherein the area to be treated is a portion of a plant.
